(19) United States
(12) Patent Application Publication
(10) Pub. No.: US 2007/0034821 A1
(43) Pub. Date: Feb. 15, 2007

(54) Adjustable sealing means

(76) Inventor: Nicolas Paul, Varenness (CA)

Correspondence Address: Robert Brouillette, 1550 Metcalfe, Suite 800, Montreal, QC, H3A 1X6, CA

(21) Appl. No.: 10/577,476

(22) PCT Filed: Oct. 28, 2004
(86) PCT No.: PCT/CA04/01890

§ 371 Date: Apr. 27, 2006

(30) Foreign Application Priority Data
Oct. 31, 2003 (CA) 2,447,866
Oct. 28, 2004 (CA) 2,486,008

(51) Int. Cl. F16K 31/44

(52) U.S. Cl. 251/214

(57) ABSTRACT

A valve has a valving element which is rotatably fitted within a valve body. This valving element of the valve is joined by a stem or shaft portion which extends out of the valve body to interact with an actuator and transmit torque to the valving element. In plug valves, pressure needs to be also applied to the valving element to insure a proper closure. The invention relates to a mechanism to adjustably seal the stem/body interface using only one screw that is positioned on the front of the valve cover for easy access. The force generated by the screw is transposed into a vertical force and a horizontal force by a cam. The multiple faces of the cam are used to transmit the force vertically and horizontally and will maintain the mechanism in a straight position.

### BACKGROUND

It is common and usual practice in sealing the top portion of rotary valves to use a top seal that seals against media leakage while simultaneously accommodating rotational movement of the valving element relative to a valve body. The valving element of a rotary valve has a closure portion which is rotatably fitted within a valve body. This closure portion of the valve is joined by a stem or shaft portion which extends out of the valve body to interact with an actuator and transmit torque to the closure portion. This torque is used to rotate the closure portion within the valve body and to open or close a passageway in the valve.

In plug valves, it is common practice to seal the top of the valve with a centrally apertured diaphragm with the shaft portion of the valve extending through the central aperture of the top seal. The mechanism for the adjustment of plug valves normally turns around the compression of two sealing parts to prevent leakage. These mechanisms involve normally a plurality of tightening bolts or screws (usually three but sometimes two).

Examples of such valves can be seen in U.S. Pat. No. 3,235,272 (Smith); U.S. Pat. No. 4,159,818 and U.S. Pat. No. 4,475,713 (Reed et al.).

While all of the above mentioned sealing arrangements have been highly satisfactory, they are not without their attendant disadvantages. For example, the tightening bolts or screws often need to be screwed simultaneously to prevent unwanted side loading on the system. Furthermore, these bolts or screws can be difficult to access with tools, especially in case of toxic leakage. As a result, these screws are rarely adjusted which reduces the effective life of the valve.

It is thus an object of the present invention to provide an adjustable stem sealing means which uses a single screw that is positioned on the front of the cover for easy access, and eliminating any interference with future automation devices to be installed on the valve.

It is a further object of the present invention to provide a top valve adjustable seal which provides for ease of adjustment when the valve is serviced in the field and which does not require special tools.

It is yet another object of the present invention to provide plug valve adjustment means which comprises a cam.

### SUMMARY OF THE INVENTION

Our mechanism uses only one adjustment screw that is positioned on the front of the cover for easy access. The force generated by the screw is transposed into a vertical force and a horizontal force by a cam. The multiple faces of the cam are used to transmit the force vertically and horizontally and will maintain the mechanism in a straight position.

Preferably, the top of the cam is used to indicate its position. As the cam is rotated, an arrow will point its position relative to the graduation on the cover. Also as the cam is rotated it's vertical motion downward can be used as an indication of the adjustment measured by the part of the cam that is outside the cover, it indicates the amount of compression that is left before the maximum compression is reached (when the top face of the cam mates the top of the cover).

The base of the cam can be shaped to fit any type of seal or purpose; for example an o-ring or a p-seal. The angle of the compression plate or the like can be varied as needed to redistribute the compression in radial and axial direction on the seal.

### BRIEF DESCRIPTION OF THE DRAWINGS

Other objects and advantages of the invention will become apparent when reading the following detailed description and upon reference to the drawings, in which:

FIG. 1A is a perspective view of a plug valve made in accordance with the present invention.

FIG. 1B is a perspective view of the plug valve shown in FIG. 1A on which a mounting bracket is attached.

FIG. 2A is a fragmentary perspective view of the plug valve shown in FIG. 1A.

FIG. 2B is another fragmentary perspective of the plug valve shown in FIG. 1A.

FIG. 3 is a top view of the plug valve shown in FIG. 1A.

FIG. 4 is a side view of the plug valve shown in FIG. 1A.

FIG. 5 is an end view of the plug valve shown in FIG. 1A.

FIG. 6A is a partial top view of the plug valve shown in FIG. 1A.

FIG. 6B is a fragmentary perspective view of the plug valve shown in FIG. 1A.

FIG. 7 is a cross sectional view of the plug valve shown in FIG. 6A.

FIG. 8 is a perspective view of the cover and of the adjustment cam (unassembled) of the plug valve shown in FIG. 1A.

FIG. 9 is a top view of the cover and of the adjustment cam shown in FIG. 8.

FIG. 10 is a bottom view of the cover and of the adjustment cam shown in FIG. 8.

FIG. 11 is a bottom perspective view of the cover and of the adjustment cam shown in FIG. 8.

FIG. 12A is a bottom perspective view of the cover and of the adjustment cam shown in FIG. 8 (assembled and in a first position).

FIG. 12B is a bottom perspective view of the cover and of the adjustment cam shown in FIG. 8 (assembled and in a second position).

FIG. 12C is a bottom perspective view of the cover and of the adjustment cam shown in FIG. 8 (assembled and in a third position).

FIG. 13 is a fragmentary cross sectional view of a the cover and top seal of the plug valve shown in FIG. 1A.

FIG. 14 is an exploded perspective view of an adjustable sealing device in accordance with this invention.

FIG. 15 is a top view of the adjustable sealing device shown in FIG. 14 in its minimum (A), intermediary (B) and maximum (C) compression positions.

FIG. 16 is a cross-sectional view of the adjustable sealing device shown in FIG. 15 in its minimum (A), intermediary (B) and maximum (C) compression positions.

FIG. 17 is a partial perspective sectional view of the adjustable sealing device shown in FIG. 15 in its minimum (A), intermediary (B) and maximum (C) compression positions.

FIG. 18 is a top view of the adjustment cam/screw shown in FIG. 14 in their minimum (A), intermediary (B) and maximum (C) compression positions.

While the invention will be described in connection with a preferred embodiment, it will be understood that it is not intended to limit the invention to that embodiment. On the contrary, it is intended to cover all alternatives, modifications and equivalents as may be included within the spirit and scope of the invention as defined by the appended claims. More particularly, the invention, although mostly described in relation to plug valves, is not limited thereto. It is applicable to any valve or any other device having a stem or shaft extending from a body that requires an adjustable seal.

### DETAILED DESCRIPTION OF THE PREFERRED EMBODIMENT

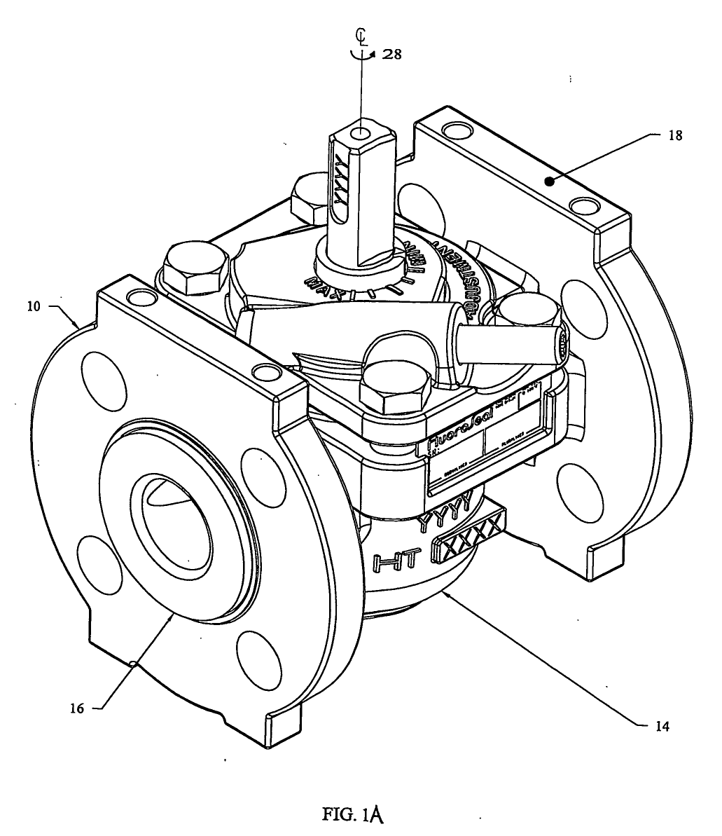

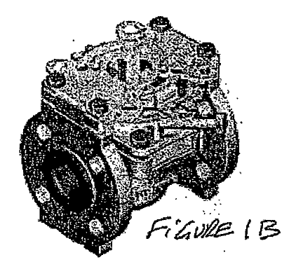

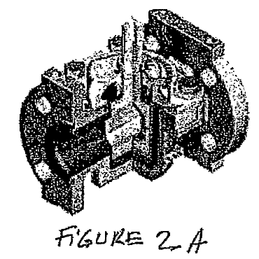

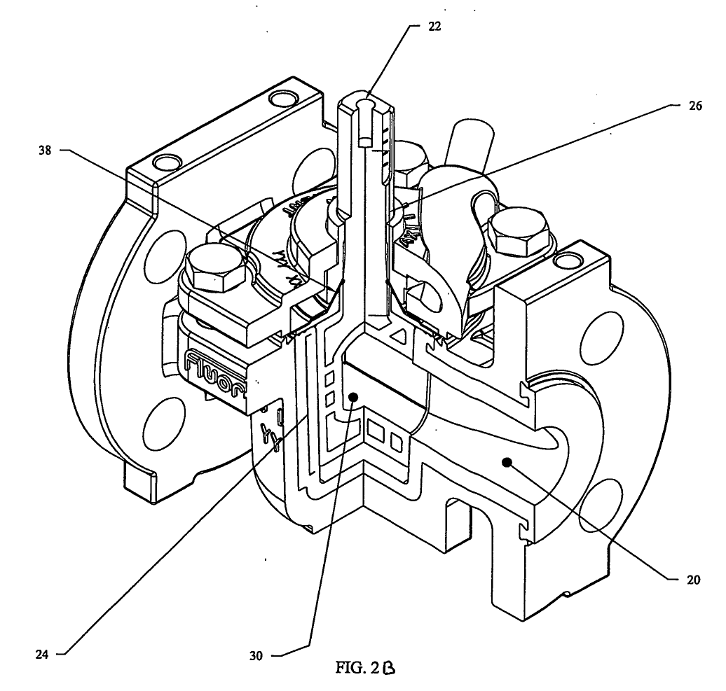

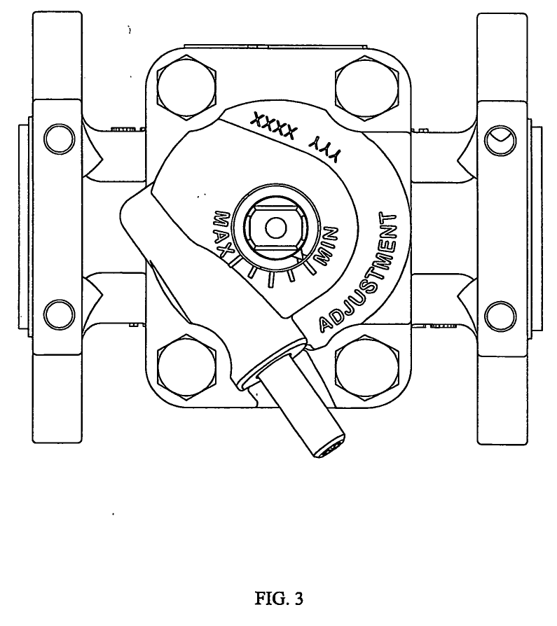

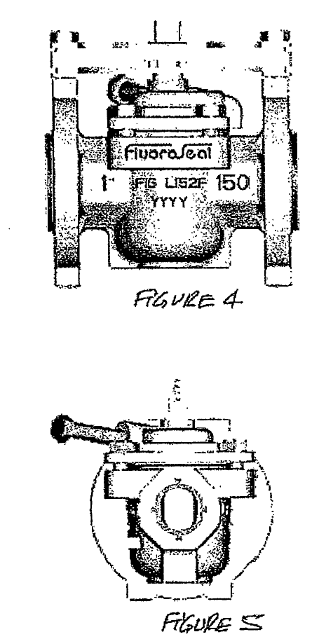

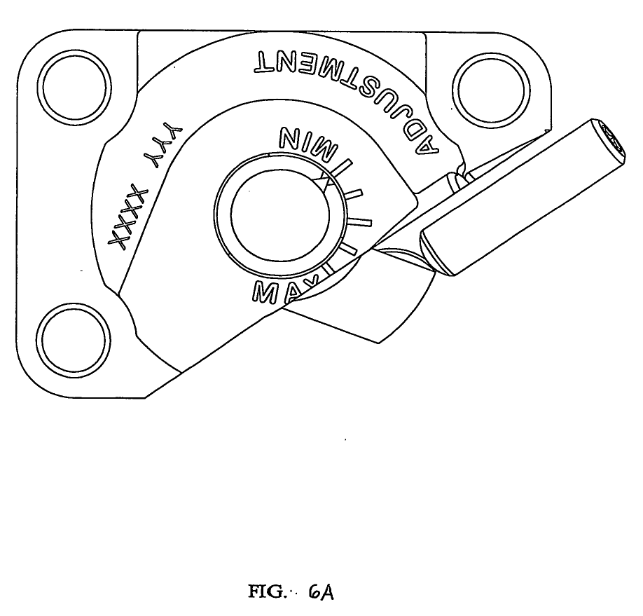

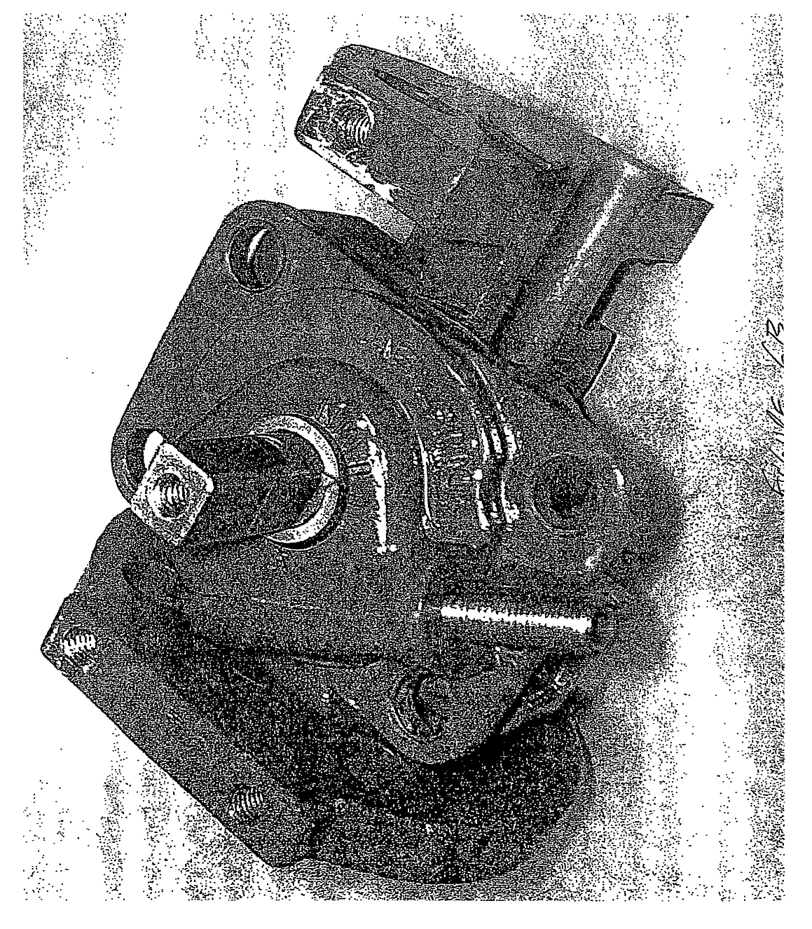

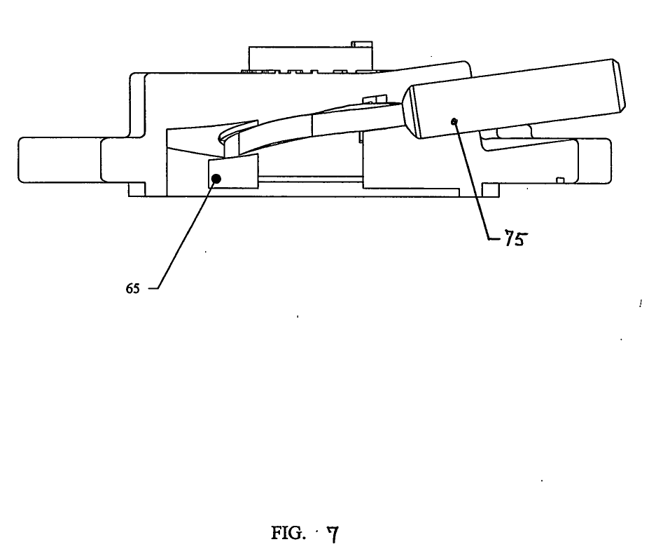

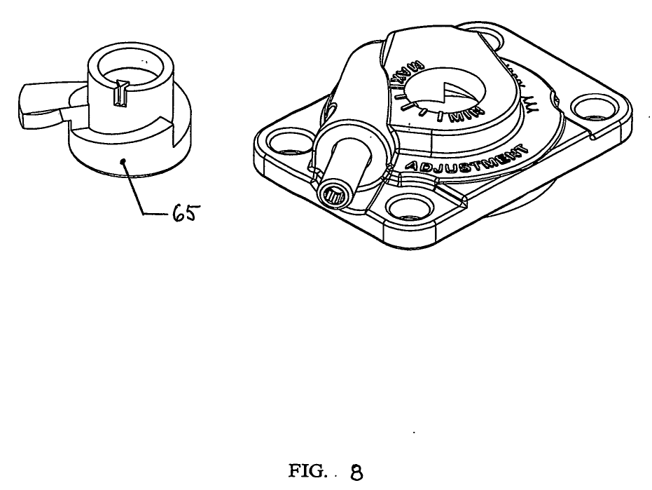

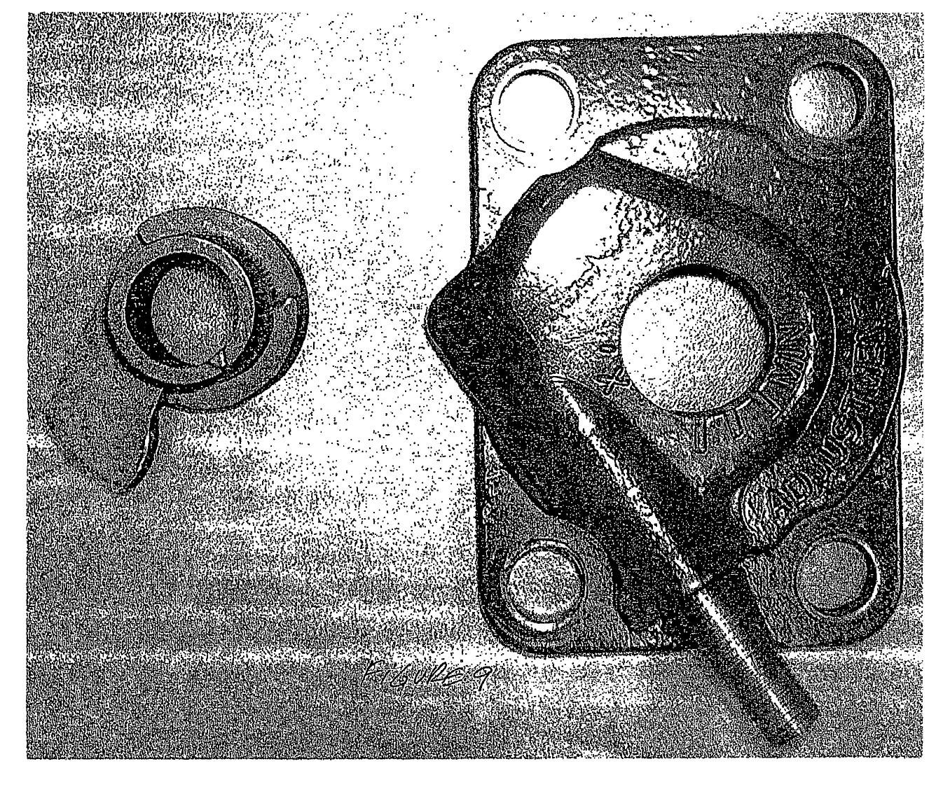

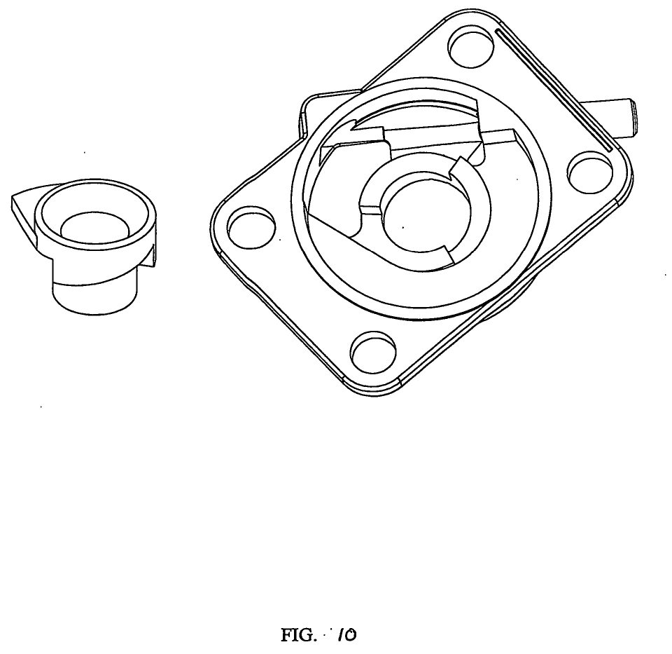

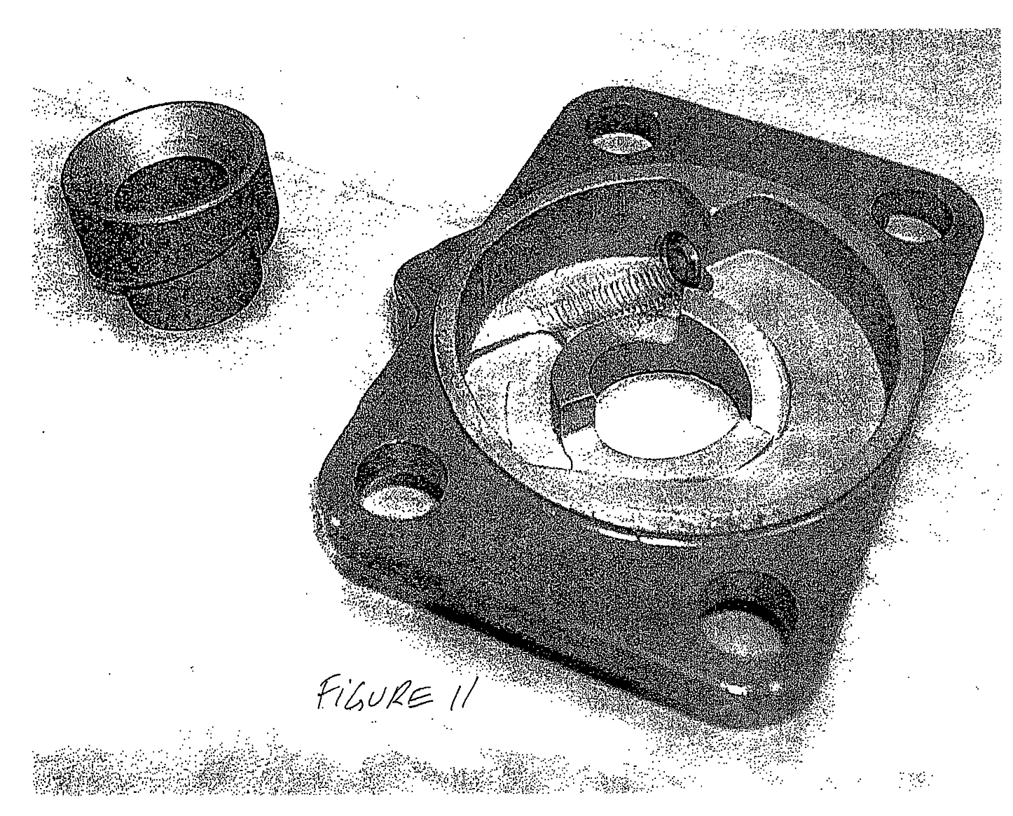

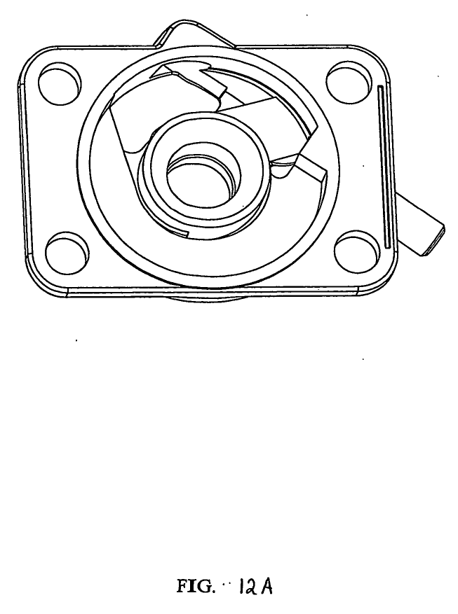

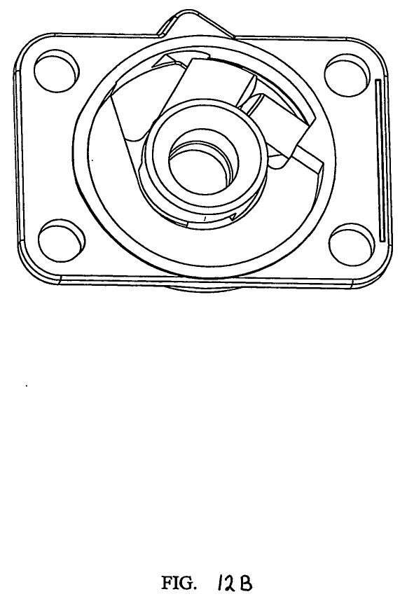

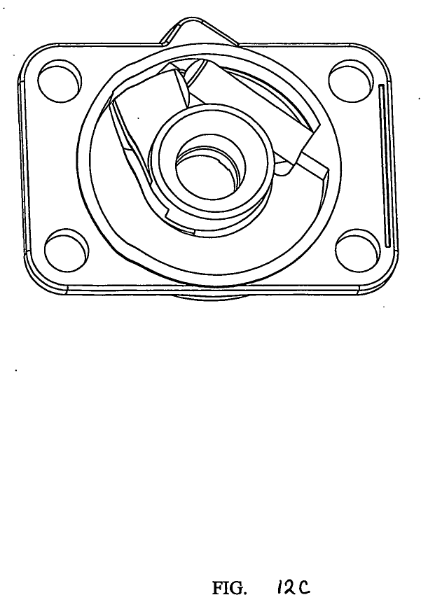

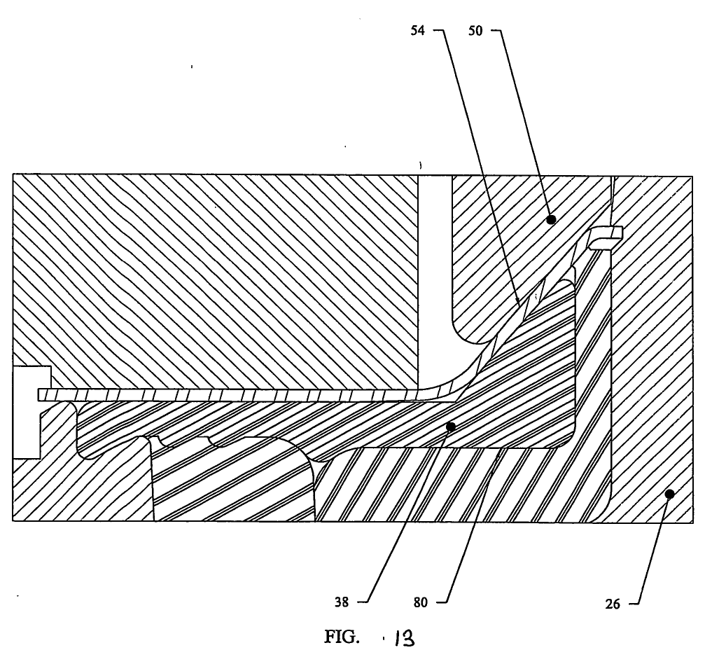

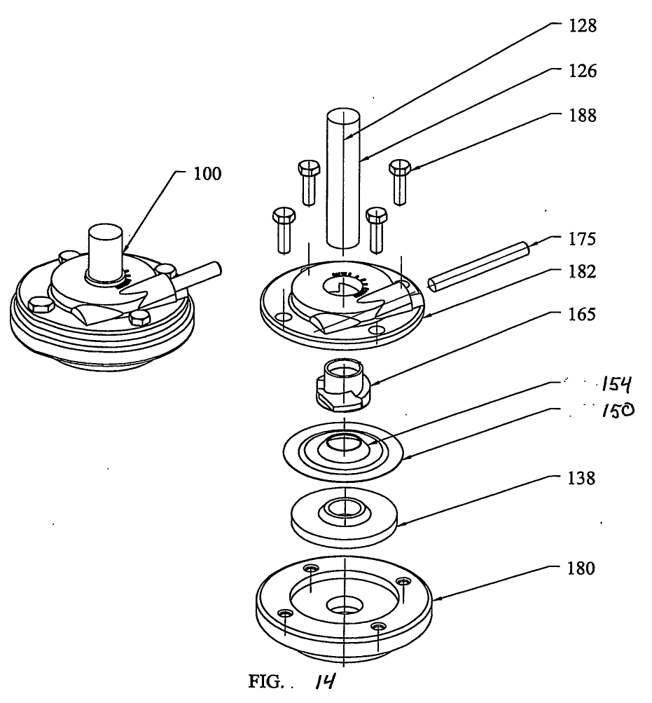

Referring now to the drawings and to FIG. 1A and 2B in particular, a plug valve 10 constructed in accordance with the present invention is shown. The plug valve 10 includes a valve body 14 having an inlet 16 and an outlet 18 with an internal flow passage 20 extending therebetween. A rotatable valving member 22 extends across the internal flow passage 20 to selectively block fluid flow therethrough. This valving member 22 is rotatably disposed within the valve body 14 of the illustrated embodiment and has a plug portion 24 which extends across the flow passage 20. A stem portion 26 of the rotatable valving member 22 is attached to the plug portion 24 to extend out of the valve body 14. Under normal circumstances, the stem portion 26 is interconnected with an actuator (not shown, either manual or automatic) which transmits a torque to the valving member 22 to effectuate relative rotation of the valving member 22 relative to the valve body 14 along a rotational axis 28. The plug portion 24 of the valving member 22 has a through opening or passageway 30 therein, as is usual, to be placed in and out of registry with the internal flow passage 20 incident to partial rotation of the valving member 22 about the axis 28. In the illustration of FIG. 2B, the valving member 22 is shown in an open position. In this open position, the passageway 30 through the plug portion 24 registers with the internal flow passage 20. As should be readily apparent, the valving member 22 is designed to be rotated about this axis 28 to place its through passageway 30 out of registry with the valve housing's (14) internal flow passage 20 and to completely cut off flow through that internal flow passage 20.

A first or primary sealing member in the form of a sleeve or liner formed of a fluorinated hydrocarbon polymeric material such as polytetrafluoroethylene, sold under the trademark TEFLON, or equivalent material is preferably fitted about the periphery of the plug portion 24 of the valving member 22 and is aperatured in correspondency to that plug portion 24 to permit registry of the plug portions (24) through passageway 30 with the internal flow passage 20 whenever valving member 22 is in the open position illustrated in FIG. 2B. The sealing member is snugly fitted on opposite sides of the internal flow passage 20 and provides a seal between the plug portion 24 of the valving member 22 and the valve body 14.

As mentioned above, the stem or shaft portion 26 of the valving member 22 extends out of the body 14. In the illustration of FIG. 2B, this extension is through an opening in the top of the valve body 14, and for purposes of the present description, this opening will be referred to as a top opening (although the valve could clearly be oriented differently). This top opening is covered with a top seal in a form of a diaphragm 38 which is aperatured to accommodate the stem portion of the valving member 22 which passes through the top seal/diaphragm 38. The top seal/diaphragm 38 will initially be described as having been formed of a fluorinated hydrocarbon polymer such as polytetrafluoroethylene or equivalent material. However, as will be highlighted below, the design of the top seal 38 is such to permit the use of a wide range of shapes and materials to meet a correspondingly wide range of applications.

The top seal 38 and the cooperating components of the valve 10 with which it interacts allow movement between the valve body 14 and the plug 22 to occur without interrupting the sealing function provided by the top seal 38. Plug portion 22 has a taper from the top of the plug (proximal to stem 26) to the lower portion of the plug (distal to the stem 26). This taper of the plug 26 allows for downward adjustability of the plug by increasing the pressure of tightening bolt 75 which in turn will apply pressure to the cam 65. Downward adjustment of plug 22 relative to the body 14 increases the service pressure of the valve 10, permitting use of higher pressurized content without leakage. Increasing the surface pressure of the valve also increases the torque required to rotate the plug 22 relative to the body 14.

Tightening of the seal tightening cam 65 applies a downward force on the thrust collar 50. This downward force is principally applied to the obliquely oriented bearing surface 54 which, in turn, applies a force to the rotatable valving member 22 in a direction substantially perpendicular to that of the bearing surface 54. The result in the force applied to the rotating valving member 22 has two components, a first downward component in the direction of arrow 70 and a second horizontal component in the direction of arrow 72. The two resulting components of force urge the top seal 38 in sealing engagement with both the stem portion 26 and the shoulder 80 of the rotatable valving member.

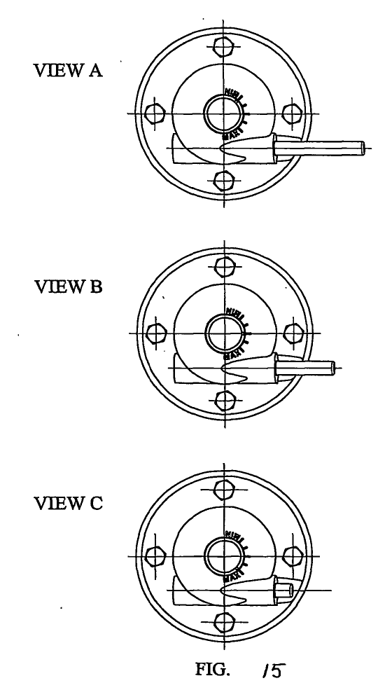

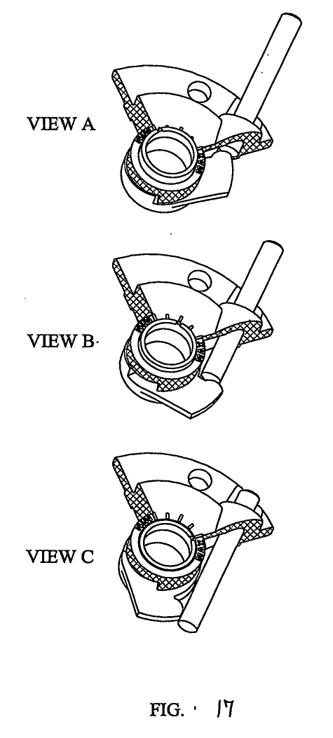

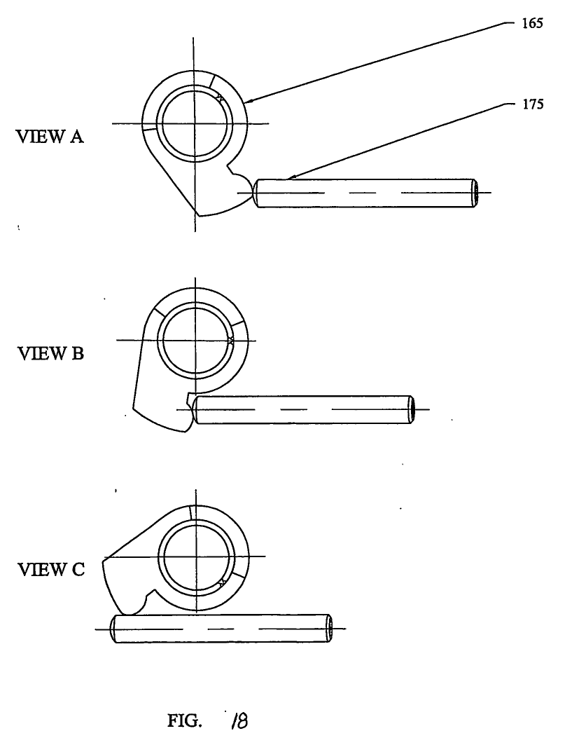

FIGS. 14-18 show another embodiment of the invention. In this embodiment, a stem sealing device 100 comprises a base 180, a seal 138, a thrust collar 150, a cam 165, a cover 182 and a bolt or screw 175.

The base 180 may be replaced by a similarly configured portion of the body of the object to be sealed. Bolts 188 are used to securely press the cover 182, the cam 165, the thrust collar 150 and the seal 138 to the base 180 and/or body.

The stem 126 is introduced in the central opening in the stem sealing device 100. Then the bolt/screw 175 is tightened as needed.

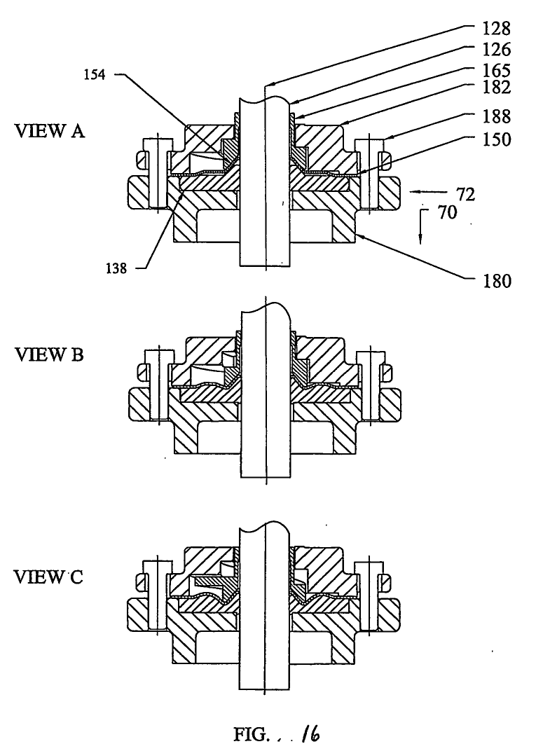

FIGS. 15-18 show the stem sealing device 100 in its minimum (A), intermediary (B) and maximum (C) compression positions.

Thus, it is apparent that there has been provided, in accordance with the invention, a top seal that fully satisfies the objects, aims and advantages set forth above. While the invention has been described in conjunction with a specific embodiment thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

I claim:

1. An adjustable sealing device for preventing the leakage of a substance contained in a containment device comprising a cam and means to actuate said cam wherein the linear movement of said actuating means creates a rotational and vertical movement of said cam.

2. An adjustable sealing device as claimed in claim 1, wherein said cam actuating means comprises a bolt or screw.

3. An adjustable sealing device as claimed in claim 1, wherein said cam actuating means comprises a single bolt or screw

4. An adjustable sealing device as claimed in claim 3, further comprising a cam position indicator.

5. An adjustable sealing device as claimed in claim 4, wherein said containment device is a valve.

6. An adjustable sealing device as claimed in claim 4, wherein said containment device is a plug valve.

7. An adjustable sealing device for preventing the leakage of a substance contained in a containment device comprising:
a. a cover;
b. a cam;
c. a seal;
d. means to press said cam against said seal;
wherein the linear movement of said pressing means creates a rotational and vertical movement of said cam, said vertical movement pressing said cam against said seal.

8. An adjustable sealing device as claimed in claim 7, wherein said pressing means comprises a bolt or screw acting on said cam.

9. An adjustable sealing device as claimed in claim 8, wherein said pressing means comprises a single bolt or screw.

10. An adjustable sealing means as claimed in claim 7, further comprising a thrust collar located between said cam and said seal and wherein the linear movement of said pressing means creates a rotational and vertical movement of said cam, said vertical movement pressing said cam against said thrust collar and said thrust collar against said seal.

11. An adjustable sealing device for preventing the leakage of a substance contained in a containment device having a body and a stem, said sealing device comprising:
a. a cover having an aperture;
b. means to fasten said cover onto said containment device body;
c. a cam;
d. means to actuate said cam;
e. a generally circular seal;
wherein said cam is rotatably fitted into said cover and wherein the linear movement of said actuating means creates a rotational and vertical movement of said cam, said vertical movement compressing said cam against said seal and said seal around said stem.

12. An adjustable sealing device as claimed in claim 10, wherein said means to actuate said cam comprises a bolt or screw acting on said calm.

13. An adjustable sealing device as claimed in claim 11, wherein said means to actuate said cam comprises a single bolt or screw.

14. An adjustable sealing device as claimed in claim 10, further comprising a generally circular thrust collar located between said cam and said seal and wherein the linear movement of said actuating means creates a rotational and vertical movement of said cam, said vertical movement compressing said cam against said thrust collar, said thrust collar against said seal and said seal around said stem.

15. An adjustable sealing device for preventing the leakage of a substance contained in a containment device having a body and a stem, said sealing device comprising:
a. a cover having an aperture;
b. means to fasten said cover onto said containment device body;
c. a cam rotatably fitted into said cover;
d. means to actuate said cam;
e. a generally circular seal;
wherein said cam has an angular lower portion, wherein said seal has a flat outer portion and an angular inner portion and wherein the linear movement of said means to actuate said cam creates a rotational and vertical movement of said cam, said vertical movement compressing said cam against said thrust collar, said thrust collar against said seal and said seal around said stem.

16. An adjustable sealing device as claimed in claim 15, wherein said means to actuate said cam comprises a bolt or screw acting on said cam.

17. An adjustable sealing device as claimed in claim 16, wherein said means to actuate said cam comprises a single bolt or screw.

18. An adjustable sealing device as claimed in claim 15, further comprising a generally circular thrust collar having a flat outer portion and an angular inner portion and located between said cam and said seal and wherein the linear movement of said actuating means creates a rotational and vertical movement of said cam, said vertical movement compressing said cam against said thrust collar, said thrust collar against said seal and said seal around said stem.

19. An adjustable sealing device for preventing the leakage of a substance contained in a containment device comprising a cam, means to actuate said cam and a cam position indicator wherein the linear movement of said actuating means creates a rotational and vertical movement of said cam.
